(19) United States
(12) Patent Application Publication
(10) Pub. No.: US 2006/0174315 A1
(43) Pub. Date: Aug. 3, 2006

(54) System and method for providing sign language video data in a broadcasting-communication convergence system

(75) Inventors: Kwan-lae Kim, Yongin-si (KR); Jeong-Rok Park, Hwaseong-si (KR); Jeong-Seok Choi, Seoul (KR); Chang-Sup Shim, Seoul (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/331,989

(22) Filed: Jan. 13, 2006

(30) Foreign Application Priority Data
Jan. 31, 2005 (KR) 2005-8624

(51) Int. Cl. H04N 7/00; H04N 11/00; H04N 7/16

(52) U.S. Cl. 725/136; 348/468

(57) ABSTRACT

A system having a transmitter and a receiver provides sign language video data in a broadcasting-communication convergence system. A transmitter extracts data, to which a sign language is to be applied, from the multimedia data, converts the extracted data into motion data, converts the motion data into an avatar motion schema indicative of avatar motion data, converts the avatar motion schema into metadata, multiplexes the multimedia data and the metadata, and transmits the multiplexed data. A receiver receives the multiplexed data, demultiplexes the received multiplexed data, extracts an avatar motion schema using the metadata, generates sign language video data by controlling a motion of an avatar through the avatar motion schema, multiplexes the sign language video data and the multimedia data, and transmits the multiplexed data to a display unit.

### CLAIM OF PRIORITY

This application claims the benefit of an earlier filed application entitled “System and Method for Providing Sign Language Video Data in a Broadcasting-Communication Convergence System,” filed in the Korean Intellectual Property Office on Jan. 31, 2005 and assigned Serial No. 2005-8624, the entire contents of which are hereby incorporated by reference.

### BACKGROUND OF THE INVENTION

1. Field of the Invention The present invention relates generally to a broadcasting-communication convergence system such as a Local Multipoint Communication Service (LMCS) system, and in particular, to a system and method for providing sign language video data along with multimedia data by applying sign language avatars to the multimedia data.

2. Description of the Related Art

The convergence of broadcasting and communication networks is possible mainly due to the development of digital technology. The latest digital technology, which digitalizes all types of information, has made a line of demarcation between audio data and video data meaningless. In addition, a broadcasting network and a communication network are being integrated into a single broadcasting-communication convergence network, causing a dramatic increase in the amount of multimedia data such as a convergence network.

In the broadcasting-communication convergence system, deaf users have many difficulties in processing the multimedia data. For the deaf persons, some broadcasting stations provide the multimedia data with broadcast caption data along. However, most deaf persons are more familiar with a sign language, as compared with the written characters. Therefore, for some broadcast programs, such as a news program, the broadcasting stations broadcast corresponding sign language performed by a live person while transmitting the associated multimedia data. However, when transmitting multimedia data for the deaf persons in this manner, the broadcasting stations must record the corresponding sign language performed by a person, causing an increase in the broadcasting cost.

Accordingly, there is a need, in the broadcasting-communication convergence network, for a system and method for providing sign language video data to deaf persons using sign language avatars when transmitting multimedia data.

### SUMMARY OF THE INVENTION

One aspect of the present invention is to provide a system and method for providing sign language video data in a broadcasting-communication convergence system.

Another aspect of the present invention is to provide a system and method for including sign language video data for deaf persons in multimedia data prior to transmitting the multimedia data in a broadcasting-communication convergence system.

Another aspect of the present invention is to provide a system and method for providing sign language video data to deaf persons using sign language avatars in a broadcasting-communication convergence system.

Yet another aspect of the present invention is to provide a system and method for providing sign language video data by linking a domestic sign language with a foreign sign language.

In one embodiment, there is provided a system for providing sign language video data in a broadcasting-communication convergence system having a transceiver for transmitting/receiving multimedia data. The system includes a transmitter for extracting data, to which a sign language is to be applied, from the multimedia data, converting the extracted data into motion data, converting the motion data into an avatar motion schema indicative of avatar motion data, converting the avatar motion schema into metadata, multiplexing the multimedia data and the metadata, and transmitting the multiplexed multimedia data and metadata; and a receiver for receiving the multiplexed multimedia data and metadata, demultiplexing the received multiplexed multimedia data and metadata, extracting an avatar motion schema using the metadata, generating sign language video data by controlling a motion of an avatar through the avatar motion schema, multiplexing the sign language video data and the multimedia data, and transmitting the multiplexed sign language video data and multimedia data to a display unit.

In another embodiment, there is provided a system for providing sign language video data in a broadcasting-communication convergence system having a transceiver for transmitting/receiving multimedia data. The system includes a receiver for receiving multimedia data, demultiplexing the received multimedia data, extracting data, to which a sign language is to be applied, from the multimedia data, converting the extracted data into motion data, converting the motion data into an avatar motion schema indicative of avatar motion data, generating sign language video data by controlling a motion of an avatar using the avatar motion schema, multiplexing the sign language video data and the multimedia data, and transmitting the multiplexed sign language video data and multimedia data to a display unit.

In another embodiment, there is provided a method for controlling an operation of a transmitter/receiver for providing sign language video data in a broadcasting-communication convergence system. The transmitter performs the acts of: extracting data, to which a sign language is to be applied, from the multimedia data, and converting the extracted data into motion data; converting the motion data into an avatar motion schema indicative of avatar motion data, and converting the avatar motion schema into metadata; and multiplexing the multimedia data and the metadata, and transmitting the multiplexed multimedia data and metadata. The receiver performs the acts of receiving the multiplexed multimedia data and metadata, and demultiplexing the received multiplexed multimedia data and metadata; extracting an avatar motion schema using the metadata; generating sign language video data by controlling a motion of an avatar through the avatar motion schema; and multiplexing the sign language video data and the multimedia data, and transmitting the multiplexed sign language video data and multimedia data to a display unit.

In another embodiment, there is provided a method for controlling an operation of a receiver for providing sign language video data in a broadcasting-communication convergence system having a transceiver for transmitting/receiving multimedia data. The method includes the steps of: receiving multimedia data, demultiplexing the received multimedia data, extracting data, to which a sign language is to be applied, from the multimedia data, and converting the extracted data into motion data; converting the motion data into an avatar motion schema indicative of avatar motion data; generating sign language video data by controlling a motion of an avatar using the avatar motion schema; and multiplexing the sign language video data and the multimedia data, and transmitting the multiplexed sign language video data and multimedia data to a display unit.

### BRIEF DESCRIPTION OF THE DRAWINGS

The above features and advantages of the present invention will become more apparent from the following detailed description when taken in conjunction with the accompanying drawings in which:

FIG. 1 is a block diagram schematically illustrating a structure of a transceiver for providing sign language video data in a broadcasting-communication convergence system according to an embodiment of the present invention;

FIG. 2 is a block diagram schematically illustrating a structure of a sign language adaptation engine according to an embodiment of the present invention;

FIG. 3 is a block diagram schematically illustrating a structure of a receiver for providing sign language video data in a broadcasting-communication convergence system according to another embodiment of the present invention;

FIG. 4 is a flowchart schematically illustrating an operation of a transmitter according to an embodiment of the present invention;

FIG. 5 is a flowchart schematically illustrating an operation of a receiver according to an embodiment of the present invention; and

FIG. 6 is a flowchart schematically illustrating an operation of a receiver according to another embodiment of the present invention.

### DETAILED DESCRIPTION

Several exemplary embodiments of the present invention will now be described in detail with reference to the annexed drawings. In the drawings, the same or similar elements are denoted by the same reference numerals even though they are depicted in different drawings. For the purposes of clarity and simplicity, a detailed description of known functions and configurations incorporated herein has been omitted for clarity and conciseness.

The present invention proposes a system and method for extracting data, to which a sign language is to be applied, from multimedia data, generating sign language video data by controlling a motion of a sign language avatar associated with the extracted data, and displaying the generated sign language video data along with the multimedia data in a broadcasting-communication convergence system.

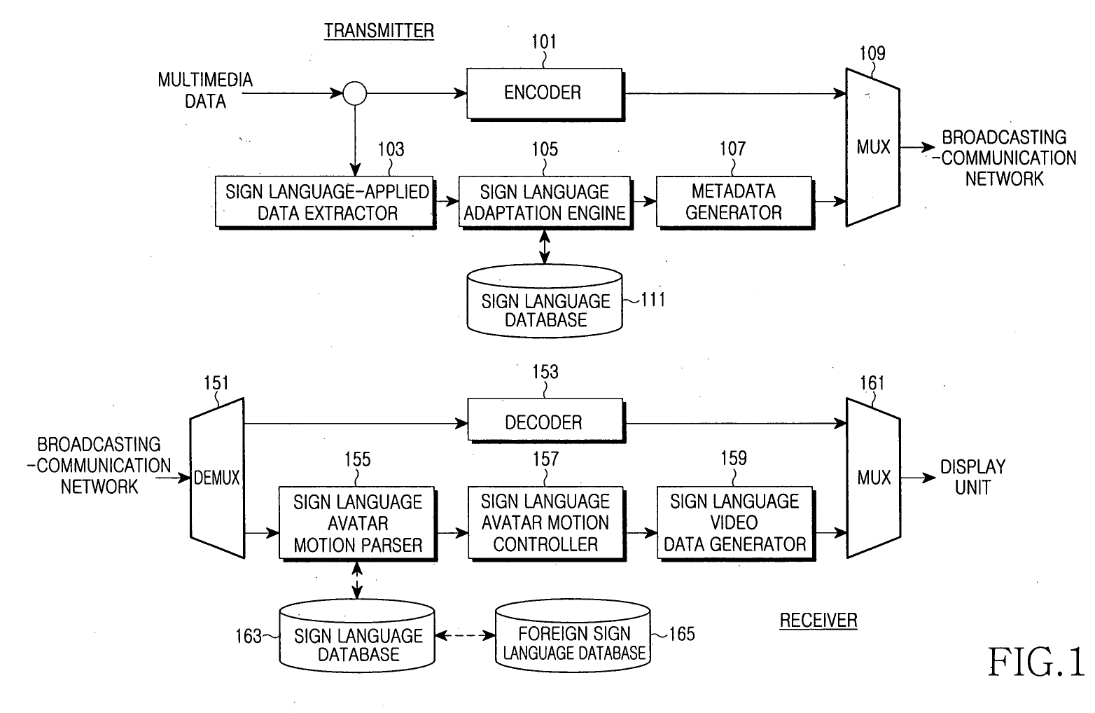

FIG. 1 is a block diagram schematically illustrating the structure of a transceiver for providing sign language video data in a broadcasting-communication convergence system according to an embodiment of the present invention.

Referring to FIG. 1, a transmitter for providing multimedia data includes an encoder 101, a sign language-applied data extractor 103, a sign language adaptation engine 105, a metadata generator 107, a multiplexer 109, and a sign language database 111. A receiver for receiving multimedia data includes a demultiplexer 151, a decoder 153, a sign language avatar motion parser 155, a sign language avatar motion controller 157, a sign language video data generator 159, and a multiplexer 161. Further, the receiver includes a sign language database 163, and uses the sign language database 163 either independently or by linking it with a foreign sign language database 165.

Now, a description will now be made of an operation of the transmitter according to an embodiment of the present invention.

In operation, the transmitter encodes the multimedia data comprised of video data and audio data using the encoder 101. In particular, the sign language-applied data extractor 103 extracts sign language-applied data to which a sign language is to be applied, for example, audio data and text data, from the multimedia data. The sign language-applied data extractor 103 outputs the extracted audio data and text data to the sign language adaptation engine 105 to which Motion Picture Experts Group-21 (MPEG-21) is applied. Note that the sign language adaptation engine 105 is an adaptation engine for MPEG-21 digital item adaptation (DIA). The sign language adaptation engine 105 performs resource adaptation and description adaptation processes on the input digital data using the MPEG-21 DIA adaptation engine.

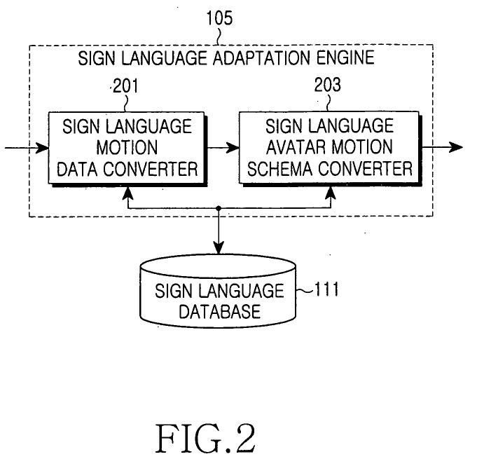

The sign language adaptation engine 105 converts the digital data into adaptation data in cooperation with the sign language database 111. A detailed structure of the sign language adaptation engine 105 will be described later with reference to FIG. 2. The sign language adaptation engine 105 converts the digital data such as audio data and text data into complexity-reduced adaptation metadata, for example, a sign language avatar motion schema generated by Extensible Markup Language (XML). The sign language adaptation engine 105 transmits the sign language avatar motion schema to the metadata generator 107. The metadata generator 107 generates metadata using the sign language avatar motion schema. The metadata includes a sign language avatar motion schema for controlling the motion of a sign language avatar associated with the multimedia data. The multiplexer 109 multiplexes the metadata and the encoded multimedia data and transmits the multiplexed data to the receiver via a broadcasting-communication convergence network.

The receiver receives the multiplexed multimedia data and metadata from the transmitter and separates the multiplexed data into multimedia data and metadata using the demultiplexer 151.

The decoder 153 decodes the multimedia data and outputs the decoded multimedia data to the multiplexer 161. The sign language avatar motion parser 155 parses the metadata to extract a sign language avatar motion schema therefrom. Here, the sign language avatar motion parser 155 parses and extracts the sign language avatar motion schema using the MPEG-21 DIA technique. The sign language avatar motion parser 155 outputs the extracted sign language avatar motion schema to the sign language avatar motion controller 157. The sign language avatar motion controller 157 controls a motion of the avatar using the sign language avatar motion schema. The sign language video data generator 159 generates sign language video data to be displayed on a display unit, using the output of the sign language avatar motion controller 157.

For a domestic sign language, the receiver can control the sign language avatar through the avatar motion schema that controls the sign language avatar in the form of metadata, simply using its own structure. However, when metadata of a foreign sign language other than the domestic sign language is received, the sign language avatar motion parser 155 converts the foreign sign language metadata into domestic sign language metadata by linking the sign language database 163 having information on the domestic sign language with the foreign sign language database 165 that has information on the foreign sign language, and parses the domestic sign language metadata. The present invention can also provide an extended method of generating a domestic sign language avatar motion schema and controlling the domestic sign language avatar motion schema in the sign language avatar motion controller 157.

FIG. 2 is a block diagram schematically illustrating the structure of a sign language adaptation engine according to an embodiment of the present invention.

Referring to FIG. 2, the sign language adaptation engine 105 has MPEG-21 DIA applied thereto and includes a sign language motion data converter 201 and a sign language avatar motion schema converter 203.

The sign language adaptation engine 105 receives data to which a sign language is to be applied, for example, audio data or text data, extracted by the sign language-applied data extractor 103.

The sign language motion data converter 201 converts the audio data or text data into sign language motion data. For example, for audio data or text data indicating ‘Go’, a ‘motion of opening a right hand and pushing the hand forward’ corresponding to ‘Go’ is stored in the sign language database 111 in the form of sign language motion data through a predetermined process.

The sign language motion data converter 201 converts the received sign language-applied data into sign language motion data stored in the sign language database 111. The sign language database 111 stores therein the sign language motion data corresponding to data to which a sign language is to be applied, i.e., audio data or text data. The sign language motion data converter 201 converts the sign language-applied data into the sign language motion data.

The sign language avatar motion schema converter 203 converts the received sign language motion data into a sign language avatar motion schema corresponding to the sign language motion data. The sign language database 111 stores therein a sign language avatar motion schema for controlling the motion of a sign language avatar corresponding to the sign language motion data. Note that the sign language avatar motion schema can be expressed in the XML language. The sign language avatar motion schema is data for controlling the motion of a sign language avatar, and the receiver controls the motion of a sign language avatar using the sign language avatar motion schema. The sign language adaptation engine 105 uses MPEG-21 in converting the sign language-applied data into sign language motion data and converting the sign language motion data into a sign language avatar motion schema.

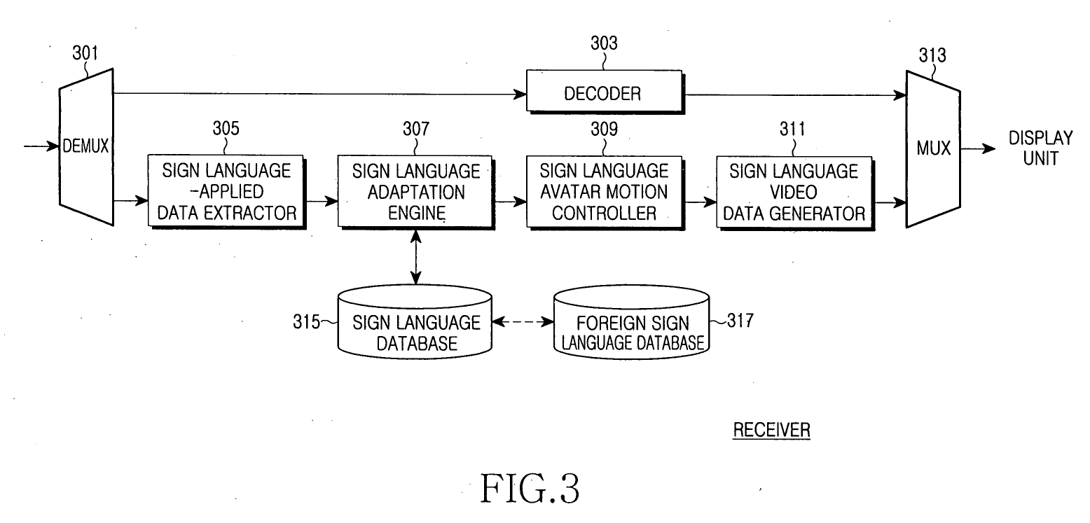

Now, a description will now be made of a structure of a receiver according to yet another embodiment of the present invention with reference to FIG. 3, which shows a block diagram illustrating the structure of a receiver for providing sign language video data in a broadcasting-communication convergence system.

Referring to FIG. 3, as the structure of a transmitter for generating the multimedia data that the receiver receives is equal to that of the transmitter described in reference to FIG. 1, a description thereof will be omitted herein to avoid redundancy.

The receiver for receiving the multimedia data from the transmitter includes a demultiplexer 301, a decoder 303, a sign language-applied data extractor 305, a sign language adaptation engine 307, a sign language avatar motion controller 309, a sign language video data generator 311, and a multiplexer 313. Further, the receiver includes a sign language database 315 and uses the sign language database 315 either independently or by linking it with a foreign sign language database 317.

Upon receiving the multimedia data transmitted from transmitter, the demultiplexer 301 of the receiver demultiplexes the received multimedia data. The decoder 303 decodes the demultiplexed multimedia data and outputs the decoded multimedia data to the multiplexer 313.

The sign language-applied data extractor 305 extracts a part of the multimedia data received from the demultiplexer 301 to apply a sign language thereto. The extracted partial data may include audio data or text data of the multimedia data. The sign language-applied data extractor 305 extracts sign language-applied data to which a sign language is to be applied, for example, audio data and text data, from the multimedia data. The sign language-applied data extractor 305 outputs the extracted audio data and text data to the sign language adaptation engine 307 to which Motion Picture Experts Group-21 (MPEG-21) is applied. The sign language adaptation engine 307 is the adaptation engine for MPEG-21 DIA, shown in FIG. 2. The sign language adaptation engine 307 performs resource adaptation and description adaptation processes on the input digital data using the MPEG-21 DIA adaptation engine.

The sign language adaptation engine 307 converts the digital data into adaptation data in cooperation with the sign language database 315 and converts the digital data such as audio data and text data into complexity-reduced adaptation metadata, for example, a sign language avatar motion schema generated by Extensible Markup Language (XML). To avoid redundancy, a detailed description of the sign language adaptation engine 307 generating the sign language avatar motion schema using MPEC-21 will be omitted herein as they are described fully in reference to FIG. 2.

The sign language adaptation engine 307 may also receive the signal transmitted by the transmitter shown in FIG. 1. The sign language adaptation engine 307 may include a function of the sign language avatar motion parser 155. Therefore, when the input multimedia data is metadata including a sign language avatar motion schema for the multimedia data from overseas, the sign language adaptation engine 307 converts the input multimedia data from overseas into domestic sign language avatar schema in cooperation with the foreign sign language database 317 in order to convert the foreign sign language into a domestic sign language. The sign language adaptation engine 307 generates a sign language avatar motion schema and outputs the generated sign language avatar motion schema to the sign language avatar motion controller 309. The sign language avatar motion controller 309 controls the motion of a sign language avatar using the received sign language avatar motion schema. Thereafter, the sign language video data generator 311 generates sign language video data to be displayed on a display unit, using the output of the sign language avatar motion controller 309.

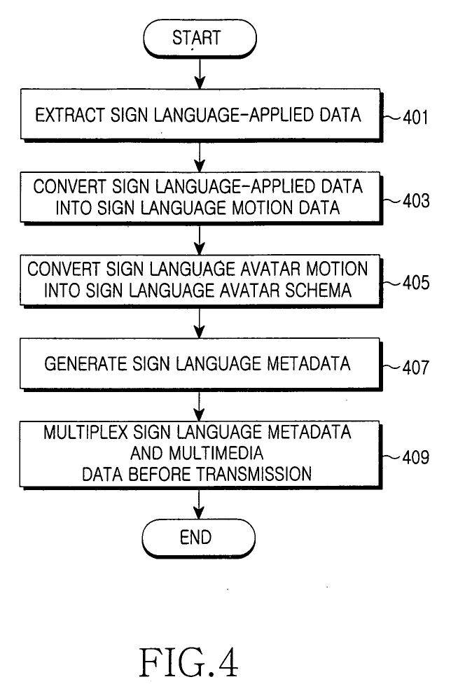

Hereinafter, a description will be made to an operation of a transmitter for providing the sign language video data in details with reference to FIG. 4, which shows a flowchart schematically illustrating an operation of a transmitter according to an embodiment of the present invention.

Referring to FIG. 4, in step 401, a transmitter extracts sign language-applied data to which a sign language is to be applied, for example, audio data and text data, from multimedia data. In step 403, the transmitter converts the extracted sign language-applied data into sign language motion data. Herein, for the multimedia data, a sign language motion for controlling the motion of a sign language avatar is previously converted in the form of data and then stored as the sign language motion data. Thereafter, the transmitter converts the sign language motion data into a sign language avatar motion schema in step 405. That is, after converting the sign language-applied data into sign language motion data, the transmitter converts the sign language motion data into a sign language avatar motion schema in order to control the motion of the sign language avatar. The process of converting the sign language-applied data into sign language motion data and converting the sign language motion data into a sign language avatar motion schema is subject to an adaptation process using MPEG-21 DIA. The sign language avatar motion schema is generated by, for example, the XML language. In step 407, the transmitter generates metadata using the sign language avatar motion schema. The metadata includes the sign language avatar motion schema for controlling the motion of a sign language avatar associated with the multimedia data. In step 409, the transmitter multiplexes the metadata and encoded multimedia data and transmits the multiplexed data to a receiver.

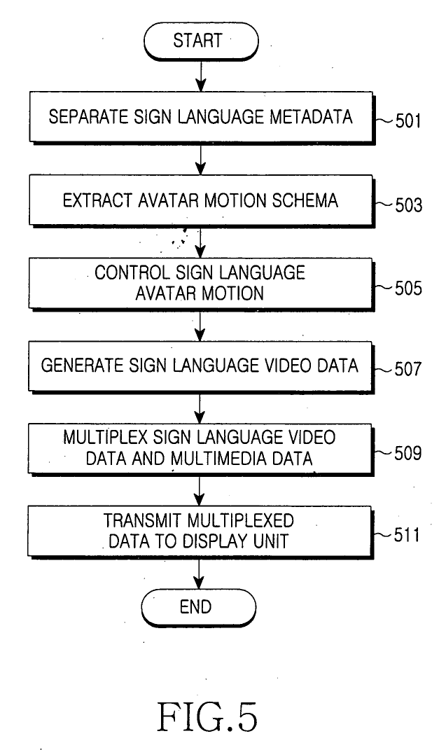

An operation of the receiver for receiving the multiplexed metadata and multimedia data will now be described with reference to FIG. 5, which shows a flowchart illustrating an operation of a receiver according to an embodiment of the present invention.

Referring to FIG. 5, in step 501, a receiver receives the multiplexed metadata and multimedia data and separates the metadata from the multiplexed data through demultiplexing. In step 503, the receiver extracts an avatar motion schema from the separated metadata. As the avatar motion schema is an avatar motion schema generated in a transmitter using MPEG-21 DIA, the receiver also parses and extracts the avatar motion schema using MPEG-21 DIA. In step 505, the receiver controls the motion of a sign language avatar using the avatar motion schema. Thereafter, in step 507, the receiver generates sign language video data to be displayed using the avatar by controlling the motion of the avatar. After generating the sign language video data, the receiver multiplexes the sign language video data and the multimedia data in step 509, and transmits the multiplexed data to a display unit in step 511. Thereafter, the display unit displays both the multimedia data and the corresponding sign language video data included in the received multiplexed data. When the metadata is metadata of a foreign sign language, the receiver converts the foreign sign language metadata into domestic sign language metadata by linking its own sign language database with a foreign sign language database. In an alternative method, the receiver can also extract a domestic sign language avatar motion schema from the metadata.

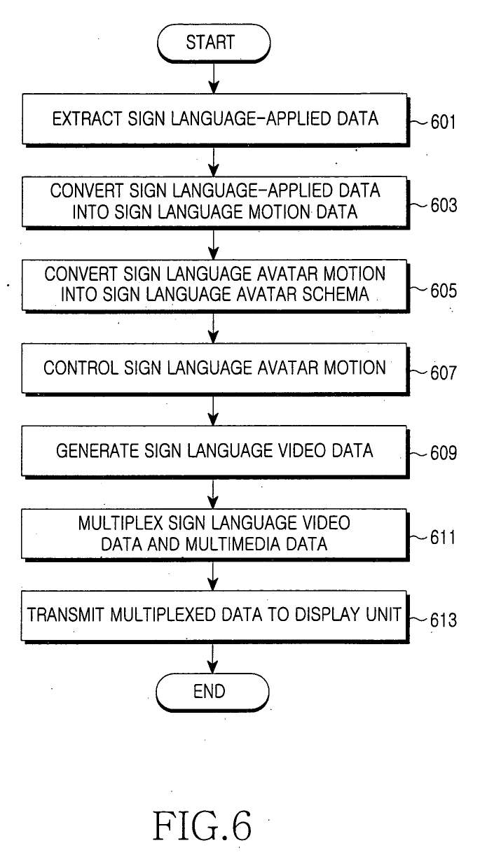

FIG. 6 is a flowchart schematically illustrating an operation of a receiver according to yet another embodiment of the present invention.

Referring to FIG. 6, a receiver receives multimedia data and extracts sign language-applied data from the received multimedia data in step 601. For example, the sign language-applied data may include audio data and text data. The receiver converts the extracted sign language-applied data into sign language motion data in step 603. Herein, for the multimedia data, a sign language motion for controlling a motion of a sign language avatar is previously converted in the form of data and then stored as the sign language motion data. Thereafter, the receiver converts the sign language motion data into a sign language avatar motion schema in step 605. That is, after converting the sign language-applied data into sign language motion data, the receiver converts the sign language motion data into a sign language avatar motion schema in order to control the motion of the sign language avatar. The process of converting the sign language-applied data into sign language motion data and converting the sign language motion data into a sign language avatar motion schema is subject to an adaptation process using MPEG-21 DIA. The sign language avatar motion schema is generated by, for example, the XML language.

In step 607, the receiver controls the motion of a sign language avatar using the sign language avatar motion schema. Thereafter, in step 609, the receiver generates sign language video data to be displayed using the avatar by controlling the motion of the sign language avatar.

After generating the sign language video data, the receiver multiplexes the sign language video data and the multimedia data in step 611, and transmits the multiplexed data to a display unit in step 613. Then the display unit displays both the multimedia data and the corresponding sign language video data included in the received multiplexed data. Similarly, when the metadata is metadata of a foreign sign language, the receiver converts the foreign sign language metadata into domestic sign language metadata by linking its own sign language database with a foreign sign language database. Herein, the foreign sign language database includes therein sign language motion data corresponding to overseas multimedia data, information on motions of sign language avatars, metadata for the sign language avatar motions, and so on.

As can be understood from the foregoing description, the present invention proposes a system and method for providing sign language video data for deaf persons during multimedia data transmission in a broadcasting-communication convergence system. A transceiver for the system which provides the sign language video data can display partial information of the received multimedia data. Hence, the inventive system can replace the conventional sign language system in which a sign language is visually performed by a person. If a foreign sign language database is built, the system is capable of translating a foreign sign language into a domestic sign language, and vice versa. In addition, for the multimedia data supporting a caption function, the system can provide sign language video data mixed with caption information.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for providing sign language video data in a broadcasting-communication convergence system including a transceiver for transmitting/receiving multimedia data; the system comprising:
a transmitter for extracting data, to which a sign language is to be applied, from the multimedia data, converting the extracted data into motion data, converting the motion data into an avatar motion schema indicative of avatar motion data, converting the avatar motion schema into metadata, multiplexing the multimedia data and the metadata, and transmitting the multiplexed multimedia data and metadata; and
a receiver for receiving the multiplexed multimedia data and metadata, demultiplexing the received multiplexed multimedia data and metadata, extracting an avatar motion schema using the metadata, generating sign language video data by controlling a motion of an avatar through the avatar motion schema, multiplexing the sign language video data and the multimedia data, and transmitting the multiplexed sign language video data and multimedia data to a display unit.

2. The system of claim 1, wherein the sign language-applied data comprises audio data or text data of the multimedia data.

3. The system of claim 1, wherein the transmitter comprises:
a sign language-applied data extractor for extracting sign language-applied data from the multimedia data;
a sign language adaptation engine for converting the extracted sign language-applied data into motion data and converting the motion data into the avatar motion schema indicative of the avatar motion data;
a sign language database including the motion data corresponding to the sign language-applied data or information on the avatar motion schema associated with the sign language, and interworking with the sign language adaptation engine;
a metadata generator for converting the avatar motion schema into metadata; and
a multiplexer for multiplexing the multimedia data and the metadata and transmitting the multiplexed multimedia data and metadata.

4. The system of claim 3, wherein the sign language adaptation engine comprises:
a sign language motion data converter for converting the sign language-applied data into the motion data using the sign language database; and
a sign language avatar motion schema converter for converting the motion data into the avatar motion schema using the sign language database.

5. The system of claim 3, wherein the sign language adaptation engine is an engine to which motion picture experts group-21 (MPEG-21) digital item adaptation (DIA) is applied.

6. The system of claim 1, wherein the receiver comprises:
a demultiplexer for demultiplexing the multiplexed multimedia data and metadata;
an avatar motion parser for extracting the avatar motion schema from the metadata;
a sign language avatar motion controller for controlling the motion of the avatar through the avatar motion schema;
a sign language video data generator for generating sign language video data corresponding to the motion of the avatar; and
a multiplexer for multiplexing the multimedia data and the sign language video data and transmitting the multiplexed multimedia data and the sign language video data to the display unit.

7. The system of claim 5, further comprising:
a sign language database for interworking with a foreign sign language database when the received metadata is foreign metadata; and
a sign language avatar motion parser for generating a domestic avatar motion schema from the sign language database.

8. A system for providing sign language video data in a broadcasting-communication convergence system including a transceiver for transmitting/receiving multimedia data; the system comprising:
a receiver for receiving multimedia data, demultiplexing the received multimedia data, extracting data, to which a sign language is to be applied, from the multimedia data, converting the extracted data into motion data, converting the motion data into an avatar motion schema indicative of avatar motion data, generating sign language video data by controlling a motion of an avatar using the avatar motion schema, multiplexing the sign language video data and the multimedia data, and transmitting the multiplexed sign language video data and multimedia data to a display unit.

9. The system of claim 8, wherein the sign language-applied data comprises audio data or text data of the multimedia data.

10. The system of claim 8, wherein the receiver comprises:
a demultiplexer for demultiplexing the multimedia data;
a sign language adaptation engine for extracting sign language-applied data from the multimedia data, converting the extracted sign language-applied data into the motion data, and converting the motion data into the avatar motion schema indicative of the avatar motion data;
a sign language database including motion data corresponding to the sign language-applied data or information on the avatar motion schema associated with the sign language, and interworking with the sign language adaptation engine;
a sign language avatar motion controller for controlling the motion of the avatar through the avatar motion schema;
a sign language video data generator for generating sign language video data corresponding to the motion of the avatar; and
a multiplexer for multiplexing the multimedia data and the sign language video data, and transmitting the multiplexed multimedia data and the sign language video data to the display unit.

11. The system of claim 10, wherein the sign language adaptation engine comprises:
a sign language motion data converter for converting the sign language-applied data into the motion data using the sign language database; and
a sign language avatar motion schema converter for converting the motion data into the avatar motion schema using the sign language database.

12. The system of claim 10, wherein the sign language adaptation engine is an engine to which motion picture experts group-21 (MPEG-21) digital item adaptation (DIA) is applied.

13. The system of claim 10, wherein the sign language database interworks with a foreign sign language database when the multimedia data is multimedia data from overseas.

14. A method for controlling an operation of a transmitter/receiver for providing sign language video data in a broadcasting-communication convergence system including the transmitter/receiver for transmitting/receiving multimedia data; the method comprising:
the transmitter comprising;
extracting data, to which a sign language is to be applied, from the multimedia data, and converting the extracted data into motion data;
converting the motion data into an avatar motion schema indicative of avatar motion data, and converting the avatar motion schema into metadata;
multiplexing the multimedia data and the metadata, and transmitting the multiplexed multimedia data and metadata; and
the receiver comprising;
receiving the multiplexed multimedia data and metadata, and demultiplexing the received multiplexed multimedia data and metadata;
extracting an avatar motion schema using the metadata;
generating sign language video data by controlling a motion of an avatar through the avatar motion schema; and
multiplexing the sign language video data and the multimedia data, and transmitting the multiplexed sign language video data and multimedia data to a display unit.

15. The method of claim 14, wherein the sign language-applied data comprises audio data or text data of the multimedia data.

16. The method of claim 14, wherein the step of converting the sign language-applied data into sign language motion data and converting the motion data into the avatar motion schema indicative of the avatar motion data is performed by motion picture experts group-21 (MPEG-21) digital item adaptation (DIA).

17. The method of claim 14, further comprising the step of, when received metadata is foreign metadata, generating a domestic avatar motion schema through a foreign sign language database.

18. A method for controlling an operation of a receiver for providing sign language video data in a broadcasting-communication convergence system including a transceiver for transmitting/receiving multimedia data; the method comprising the steps of:
receiving multimedia data, demultiplexing the received multimedia data, extracting data, to which a sign language is to be applied, from the multimedia data, and converting the extracted data into motion data;
converting the motion data into an avatar motion schema indicative of avatar motion data;
generating sign language video data by controlling a motion of an avatar using the avatar motion schema; and
multiplexing the sign language video data and the multimedia data, and transmitting the multiplexed sign language video data and multimedia data to a display unit.

19. The method of claim 18, wherein the sign language-applied data comprises audio data or text data of the multimedia data.

20. The method of claim 18, wherein the step of converting the sign language-applied data into sign language motion data and converting the motion data into the avatar motion schema indicative of the avatar motion data is performed by motion picture experts group-21 (MPEG-21) digital item adaptation (DIA).

21. The method of claim 18, further comprising the step of, when the multimedia data is multimedia data from overseas, generating a domestic avatar motion schema through a foreign sign language database.
